(19) United States
(12) Patent Application Publication
(10) Pub. No.: US 2004/0079102 A1
(43) Pub. Date: Apr. 29, 2004

(54) Vehicle air conditioner having compressi on gas heater

(76) Inventors: Makoto Umebayashi, Chiryu-city (JP); Tomohiro Inada, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/688,163

(22) Filed: Oct. 17, 2003

(30) Foreign Application Priority Data
Oct. 22, 2002 (JP) JP2002-306909

(51) Int. Cl. F25B 13/00; B60H 1/32; F25B 1/06

(52) U.S. Cl. 62/324.1; 62/160; 62/244; 62/500

(57) ABSTRACT

A vehicle air conditioner includes a casing having an air passage from which air blows out to a passenger compartment of a vehicle, a carbon-dioxide-gas compression refrigerator including a compressor, a radiator and a evaporator, an air heater for heating air that blows out from the air passage by heat generated by the vehicle and a control unit for circulating compressed carbon-dioxide-gas through the radiator if heat energy of the air heater is less than a prescribed capacity but is sufficient to heat the air blowing out to the passenger compartment.

### CROSS REFERENCE TO RELATED APPLICATION

The present application is based on and claims priority from Japanese Patent Application 2002-306909, filed Oct. 22, 2002, the contents of which are incorporated herein by reference.

### BACKGROUND OF THE INVENTION

1. Field of the Invention

The present invention relates to a vehicle air conditioner which has a radiator for a heat pump cycle of a vapor compression refrigeration cycle along with an engine-coolant type air heater in an air passage from which air blows out to a passenger compartment.

2. Description of the Related Art

In a conventional vehicle air conditioner which has a radiator for a heat pump cycle along with an evaporator of a vapor compression refrigeration cycle, such as disclosed in JP-U-61-161011, air blowing into a passenger compartment is heated by compressed vapor compressed by a compressor whenever temperature of engine coolant is lower than a prescribed level. Therefore, the compressor may be operated even when heating of the passenger compartment is not desired. This unnecessarily wastes fuel of an engine.

### SUMMARY OF THE INVENTION

In view of the above problem, an object of the invention is to provide a new and improved air conditioner which has a vapor compression refrigeration cycle and heat cycle.

Another object of the invention is to provide a highly efficient air conditioner system.

According to a feature of the invention, a vehicle air conditioner includes a casing having an air passage from which air blows out to a passenger compartment of a vehicle, a carbon-dioxide-gas compression refrigerator which includes a compressor, a radiator and a evaporator, an air heater which heats air blowing out from the air passage by heat generated by the vehicle, and first means for circulating compressed carbon-dioxide-gas through the radiator if heat energy of the air heater is less than a prescribed capacity but is sufficient to heat the air blowing out to the passenger compartment.

As a result, the heat pump cycle is prevented from operating in a season in which a large heating capacity is not necessary. Further, because carbon-dioxide-gas is used as the refrigerant, the heat pump cycle can be operated even if the outside temperature is lower than 0° C.

The above vehicle air conditioner may include a temperature sensor for detecting an outside temperature. In this case the first means is operated when the outside temperature is in a prescribed temperature range.

The above vehicle air conditioner may further include a bypass passage bypassing the air heater and the radiator through which air blows to the passenger compartment and second means for controlling a ratio of an amount of the air to pass the air heater and the radiator to an amount of the air to flow through the bypass passage. In this case, the first means circulates compressed carbon-dioxide-gas if the ratio is larger than a prescribed value.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a schematic diagram illustrating a vehicle air conditioner according to a preferred embodiment of the invention; and

FIG. 2 is a flow diagram showing operation of the vehicle air conditioner according to the preferred embodiment.

### DETAILED DESCRIPTION OF THE PREFERRED EMBODIMENTS

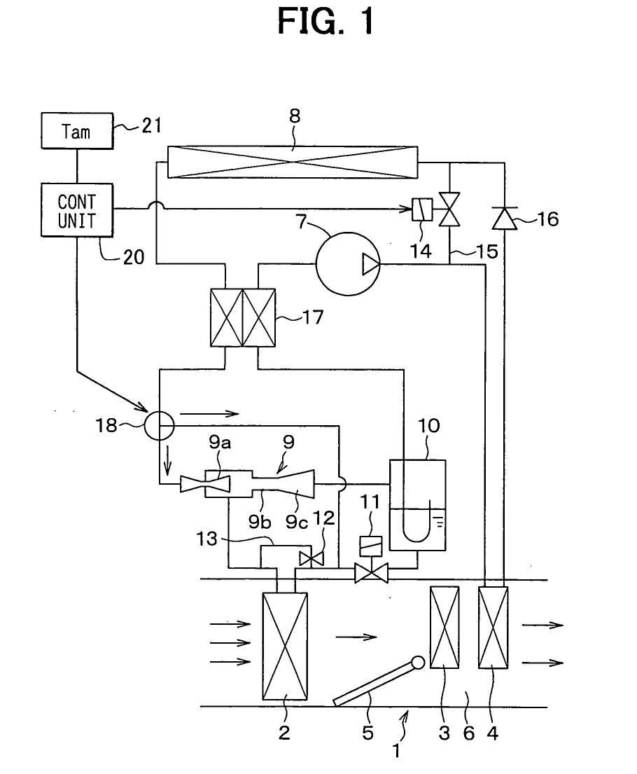

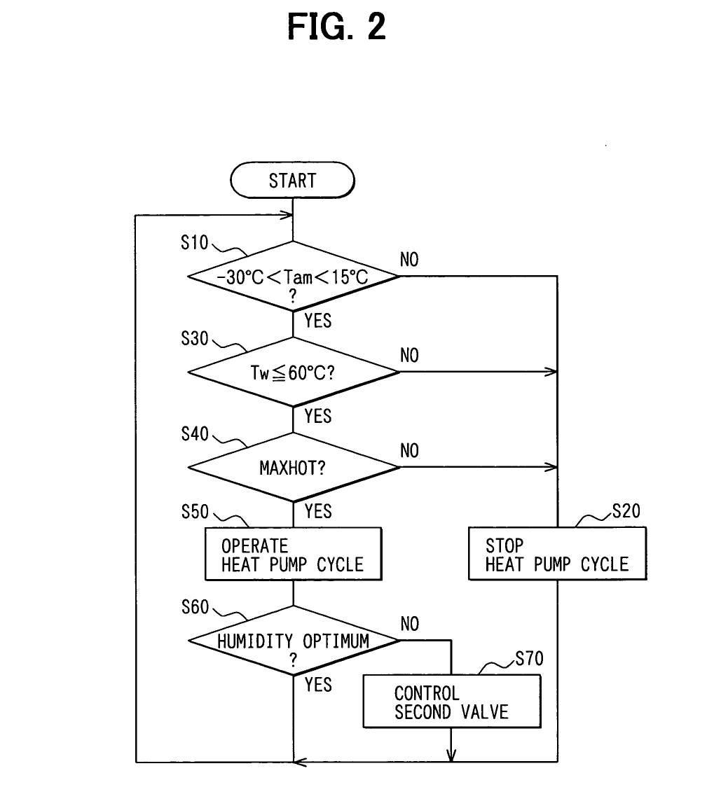

A vehicle air conditioner according to a preferred embodiment of the invention will be described with reference to FIGS. 1 and 2.

The vehicle air conditioner according to the preferred embodiment of the invention includes a casing 1, an evaporator 2, a waste heat type air heater 3, a radiator 4, an air mixing door 5, a compressor 7, a heat exchanger 8, an ejector 9, a vapor-liquid separator 10, a control unit 20 and other elements which form a vapor compression refrigeration cycle.

The casing 1 is a duct which has an air passage for air blowing into a passenger compartment of a vehicle. Although not shown, there are an inside-outside air-switching device and an air blower at an upstream side of the casing 1 and a defroster outlet, a face-blow outlet and a foot outlet at a downstream side of the casing 1.

The evaporator 2, heater 3 and radiator 4 are disposed in this order from the upstream side of the air passage to the downstream side thereof in the air passage. The air mixing door 5 changes the ratio of an amount of the air that has passed the evaporator 2 and bypasses the heater 3 and the radiator 4 through a bypass passage 6 to an amount of the air that passes through the heater 3 and the radiator 4. In other words, temperature of the air blowing to the passenger compartment is controlled according to opening angle of the air mixing door 5. Warm air increases as the air mixing door 5 opens wider, and cooling air increases as the door 5 closes. In the preferred embodiment, when the door fully opens so that the bypassing passage is completely closed, the door open ratio is defined as 100%.

The vapor compression refrigeration cycle is to take heat from depressurized vapor of a low pressure and give the heat to compressed vapor of a high pressure.

The vapor compression refrigeration cycle includes the compressor 7, the external heat exchanger 8, the ejector 9, the vapor-liquid separator 10, a first valve 11, a second valve 12, a first refrigerant bypass 13, a third valve 14, a second refrigerant bypass 15, a check valve 16, an internal heat exchanger 17 and a switching valve 18.

The compressor 7 is a variable volume compressor which is driven by an engine to compress refrigerant. The external heat exchanger 8 exchange the heat between the refrigerant and outside air.

The ejector 9 includes a nozzle 9a, a mixing portion 9b, a diffuser 9c, etc. The nozzle 9a converts the pressure energy of the high pressure refrigerant to velocity energy to expand the refrigerant. The mixing portion 9b draws vaporized refrigerant injected from the nozzle 9a and mixes the same with unvaporized refrigerant injected from the nozzle 9a The diffuser 9c also mixes the vaporized and unvaporized refrigerants and converts the velocity energy to pressure energy to increase the refrigerant pressure. In the mixing portion 9b, the drive flow of the refrigerant ejected from the nozzle 9a and the suction flow of the refrigerant drawn by the evaporator 2 are mixed so that the sum of the kinetic momentum of the drive flow and the kinetic momentum of the suction flow can be kept constant. Accordingly, the static pressure of the refrigerant in the mixing portion 9b increases. In the diffuser 9c, the sectional area of the passage gradually increases so that the velocity energy (kinetic pressure) is converted to the pressure energy (static pressure). Accordingly, the mixing portion 9b and the diffuser 9c form a pressure increasing portion of the ejector 9 that increases the refrigerant pressure. A rubber nozzle (cf. “Ryuutai Kogaku” published by Tokyo Daigaku Shuppanbu) is adopted as the nozzle of the preferred embodiment in order to increase the speed of the refrigerant ejected from the nozzle to a speed higher than the acoustic velocity. However a tapered nozzle can be substituted for it.

The vapor-liquid separator 10 receives the refrigerant ejected from the ejector 9 and separates vapor-phase refrigerant from liquid-phase refrigerant. The separator 10 has a vapor refrigerant outlet connected to an inlet of the compressor 7 and a liquid refrigerant outlet connected to the evaporator 2.

The first valve 11 reduces the pressure of the liquid-phase refrigerant that flows out of the separator 10 and opens or closes a refrigerant passage which connects the separator 10 and the evaporator 2. The second valve 12 controls the amount of the refrigerant flowing through the first bypass 13 that connects the inlet and the outlet of the evaporator 2. The second valve 12 can fully close the first bypass 13 to stop the refrigerant. The third valve 14 opens or closes the second bypass 15, through which the refrigerant flowing out of the compressor 7 bypasses the radiator 4 and flows into the external heat exchanger 8. The check valve 16 prevents the refrigerant flowing to the external heat exchanger 8 from flowing to the radiator 4 and conducts the refrigerant flowing out of the radiator 4 to the external heat exchanger 8, thereby reducing the pressure thereof.

The internal heat exchanger 17 is a heat exchanger which exchanges the heat of low pressure refrigerant before flowing into the compressor 7 with the heat of the high pressure refrigerant before being ejected by the nozzle 9a. The switching valve 18 switches flow of the refrigerant flowing out of the internal heat exchanger 17 from one to the other between the nozzle 9a and the evaporator 2.

The operation of the vapor compression refrigeration cycle of the air conditioner according to the preferred embodiment of the invention will be described below.

[Cooling Cycle Operation]

The switching valve 18 is operated so that the refrigerant flowing out of the internal heat exchanger 17 is conducted to the nozzle 9a, and the compressor 7 is operated while the second valve 12 is fully closed and the third valve 14 is fully opened.

Accordingly, the vapor-phase refrigerant that flows out of the vapor-liquid separator 10 is drawn by the compressor 7, so that almost all the compressed refrigerant is discharged to the external heat exchanger 8. The refrigerant that is cooled by the external heat exchanger 8 and sent to the ejector 9 is depressurized by the nozzle 9a and expands, thereby drawing the refrigerant in the evaporator 2. The refrigerant drawn from the evaporator 2 and the refrigerant ejected from the nozzle 9a are mixed in the mixing portion 9b, and the kinetic pressure of the mixed refrigerant is converted by the diffuser 9c into the static pressure. Then, it returns to the vapor-liquid separator 10.

Since the refrigerant in the evaporator 2 is drawn by the ejector 9, the evaporator 2 is supplied by the vapor-liquid separator 10 with the liquid-phase refrigerant that is depressurized by the first valve 11. The supplied liquid-phase refrigerant is given heat from the air blown into the passenger compartment and is vaporized. In this embodiment, carbon dioxide is used as the refrigerant, and the high-side pressure of the refrigerant or the discharge pressure of the compressor 7 is set to be higher than the critical pressure. Therefore, the refrigerant decreases its enthalpy without being condensed in the external heat exchanger 8.

[Heat Pump Cycle Operation]

The switching valve 18 is operated so that the refrigerant flows from the internal heat exchanger 17 to the evaporator 2. The third valve 14 is fully closed, and the compressor 7 is operated.

Accordingly, the refrigerant discharged by the compressor 7 circulates in the circuit starting from the compressor 7 through the radiator 4, the check valve 16, the external heat exchanger 8, the internal heat exchanger 17, the evaporator 2, the mixing portion 9b, the diffuser 9c, the vapor-liquid separator 10, the internal heat exchanger 17 and ending at the compressor 7.

Accordingly, the pressurized and heated refrigerant is cooled down after it heats up the air to blow into the passenger compartment via the radiator 4. Thereafter, it is depressurized by the check valve 16 and conducted to the external heat exchanger 8. Then, the depressurized refrigerant is given heat from the outside air via the external heat exchanger 8 and from the air blowing into the passenger compartment via the evaporator 2 and is vaporized. In this heat pump cycle operation, it is not always necessary to set the discharge pressure of the refrigerant to be higher than the critical pressure. Thus, air is cooled and dehumidified by the evaporator 2, heated by the radiator 4 and is blown into the passenger compartment.

[Air Conditioning Operation]

When a start switch of the air conditioner is turned on, whether ambient temperature Tam, which is detected by an outside temperature sensor 21, is within a prescribed temperature range (e.g. higher than −30° C. and lower than 15° C.) is examined at step S10, as shown in FIG. 2. If the temperature Tam is not within the range, the heat pump cycle is not operated at S20. Incidentally, the lowest temperature of the temperature range is set according to characteristics of the refrigerant, and the highest temperature of the temperature range is set to be as high as the temperature at which the heat pump cycle is not necessary.

On the other hand, the outside temperature Tam is in the prescribed range, whether the temperature Tw of engine coolant that flows into the heater 3 is lower than a prescribed temperature (e.g. 60° C.) or not is examined at step S30. This step is to know the heating capacity of the heater 3. If the temperature Tw of the coolant is higher than the prescribed temperature, the heat pump cycle is not operated (S20). Otherwise, whether the open ratio of the air mixing door 5 is wider than a prescribed angle MAXHOT (e.g. 90%) or not is examined at step S40. If the open ratio of the air mixing door 5 is not wider than MAXHOT, the heat pump cycle is not operated (S20).

On the other hand, if the open ratio of the air mixing door is wider than MAXHOT, the heat pump cycle is operated. Subsequently, humidity of the passenger compartment is detected at step S60 and controlled to a desired level at step S70 by the second valve 12, which controls the amount of the refrigerant flowing through the first bypass 13.

The heating capacity of the radiator 4 and the cooling capacity of the evaporator 2 are controlled by changing the discharging capacity of the compressor 7.

Thus, the heat pump cycle is operated only when the temperature of the engine coolant is lower than a prescribed temperature in a prescribed outside temperature range while the air mixing door 5 is almost fully opened. Because carbon dioxide is used as the refrigerant, the refrigeration cycle can be operated even if the outside temperature is lower than 0° C.

It is also possible to operate the heat pump cycle if the temperature is lower than a prescribed temperature while the air mixing door 5 is fully opened even if the outside temperature is out of a prescribed outside temperature range.

The compressor of the air conditioner according to the preferred embodiment is a variable capacity type compressor. However, another type such as a fixed capacity type with a clutch or a motor driven compressor can be used. In such a case, the clutch or the motor controls operation time or other conditions of the compressor.

The ejector can be substituted by a depressurizing device such as an expansion valve.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. A vehicle air conditioner comprising:
a casing having an air passage from which air blows out to a passenger compartment of a vehicle;
a carbon-dioxide-gas compression refrigeration cycle disposed in said casing, said refrigeration cycle including a compressor, a radiator disposed in said air passage and a evaporator disposed in said air passage;
an air heater, disposed in said air passage, for heating air that blows out from the air passage by heat generated by the vehicle; and
first means for circulating compressed carbon-dioxide-gas through the radiator if heat energy of said air heater is less than a prescribed capacity and is sufficient to heat the air that blows out to the passenger compartment.

2. The vehicle air conditioner as claimed in claim 1, further comprising a temperature sensor for detecting an outside temperature, wherein
said first means is operated when the outside temperature is in a prescribed temperature range.

3. The vehicle air conditioner as claimed in claim 1, further comprising a bypass passage bypassing said air heater and said radiator through which air blows to the passenger compartment and second means for controlling a ratio of an amount of the air to pass said air heater and the radiator to an amount of the air to flow through the bypass passage,
wherein said first means circulates compressed carbon-dioxide-gas through said radiator if the ratio is larger than a prescribed value.
